(19) United States
(12) Patent Application Publication
(10) Pub. No.: US 2012/0093251 A1
(43) Pub. Date: Apr. 19, 2012

(54) RADIO COMMUNICATION SYSTEM, TRANSMISSION APPARATUS, AND RECEPTION APPARATUS

(75) Inventors: Osamu Nakamura, Osaka (JP); Yasuhiro Hamaguchi, Osaka (JP); Kazunari Yokomakura, Osaka (JP); Jungo Goto, Osaka (JP); Hiroki Takahashi, Osaka (JP)

(73) Assignee: SHARP KABUSHIKI KAISHA, Osaka-shi, Osaka (JP)

(21) Appl. No.: 13/378,702

(22) PCT Filed: Apr. 23, 2010
(86) PCT No.: PCT/JP2010/057240

§ 371 Date: Dec. 30, 2011

(30) Foreign Application Priority Data
Jun. 18, 2009 (JP) 2009-145793

(51) Int. Cl. H04B 7/02

(52) U.S. Cl. 375/267

(57) ABSTRACT

To provide a radio communication system, a transmission apparatus, a central control unit, and a reception apparatus, which can enhance transmission performances without giving more interference than necessary. The radio communication system in which a plurality of transmission apparatuses 100 and 200 performs communication with a reception apparatus 300 in a coordinated manner determines a transmission method in the respective transmission apparatuses in accordance with a magnitude relation of an average reception power between the respective transmission apparatuses in the communication, and enhances the whole transmission performances. The radio communication system determines a transmission method in accordance with a magnitude relation of an average reception power. Since a significance of each channel differs depending on a magnitude of the average reception power, efficient transmission in accordance with the significance becomes possible. As the result, transmission performances can be enhanced.

### TECHNICAL FIELD

The present invention relates to a radio communication system, transmission apparatus, and reception apparatus in which a plurality of transmission apparatuses communicates with a reception apparatus in a coordinated manner.

### BACKGROUND ART

Currently, a third generation (3rd Generation; 3G) mobile phone has prevailed quickly in a market. In W-CDMA (Wideband Code Division Multiple Access) which is one of 3G communication systems, data transmission of maximum 2 Mbps is possible in stationary mode in a downlink (communication from a base station to a mobile station), and communication of maximum 14.4 Mbps speed is possible in HSPA (High Speed Packet Access) which is an extension of W-CDMA.

In order to enable further high speed data transmission, standardization of a communication system called LTE (Long Term Evolution) has been promoted and mostly completed in 3GPP (3rd Generation Partnership Project). In LTE, using the same frequency band as that of 3G, communication of maximum 100 Mbps to 300 Mbps becomes possible in a downlink.

LTE-Advanced (LTE-A) as a next generation communication system of LTE has been investigated currently. LTE-A has various technologies added to LTE, and there is CoMP (Cooperative Multi-Point) as one of them.

CoMP refers to that a plurality of base stations transmits or receives signals in a coordinated manner. It is considered that a transmission speed for a cell edge user can be enhanced by introducing CoMP. For example, by applying transmission antenna diversity, such as STTD (Space Time Transmit Diversity), SFBC (Space Frequency Block Coding), or CDD (Cyclic Delay Diversity), reception quality can be enhanced, and therefore, a cell edge throughput can be enhanced dramatically.

For example, in Non-patent Document 1, it is disclosed that error rate characteristics can be improved greatly by performing STTD encoding in a central control unit, and transmitting two encoded sequences from respective different base stations.

### PRIOR ART DOCUMENT

### Non-Patent Document

Non-patent Document 1: Manabu Inoue, Takeo Fujii, Masao Nakagawa, “Site diversity method using STTD in a plurality of OFDM base stations system”, IEICE Technical Report, Institute of Electronics, Information and Communication Engineers, July, 2002, RCS2002-127, pp. 49 to 54.

### SUMMARY OF THE INVENTION

### Problems to be Solved by the Invention

An example where a terminal performs CoMP reception with two base stations in a downlink is considered. Here, a transmission scheme is assumed to be an orthogonal frequency division multiplexing (OFDM). When the terminal is connected with two base stations, it happens in many cases that a reception power from one base station is large, and a reception power from the other is small. In this case, since an average reception power differs greatly between the two base stations (antennas), it becomes impossible to acquire the maximum transmission antenna diversity effect.

When the same data are transmitted from two base stations using the transmission antenna diversity technology mentioned above, more interference is given to other terminals because the same signal is transmitted from the two base stations. If an Alamouti code is used like the example described in Non-patent Document 1, a transmission rate will be decreased when three or more transmission antennas are used.

The present invention is made in view of such a situation, and has an object to provide, without giving more interference, a radio communication system, transmission apparatus, and reception apparatus which can improve transmission performances.

### Means for Solving the Problem

(1) For achieving the above-mentioned object, a radio communication system of the present invention is the one in which a plurality of transmission apparatuses performs communication with a reception apparatus in a coordinated manner, wherein a transmission method used by the respective transmission apparatuses is determined in accordance with a magnitude relation of an average reception power among the respective transmission apparatuses in the communication, and the whole transmission performances are enhanced.

In this way, the radio communication system of the present invention determines the transmission method in accordance with the magnitude relation of the average reception power. This makes it possible to mitigate the giving interference. In addition, since a significance of each channel differs depending on a magnitude of an average reception power, efficient transmission in accordance with the significance becomes possible. As the result, transmission performances can be enhanced.

(2) In the radio communication system of the present invention, a puncture pattern after an error correction encoding is determined in accordance with a magnitude relation of an average reception power in the reception apparatus. Thereby, in a channel where an average reception power is large, information is not changed, and in a channel where an average reception power is small, information can be punctured. As the result, even though an average reception power differs among base stations, a transmission antenna diversity effect can be acquired.

(3) In the radio communication system of the present invention, the transmission method is determined so that a transmission apparatus causing a large average reception power in the reception apparatus transmits preferentially systematic bits, and a transmission apparatus causing a small average reception power in the reception apparatus transmits preferentially parity bits.

In this way, the systematic bits which accounts for an important role in encoded bits are transmitted from the base station having the good channel state, the parity bits are transmitted from the base station having the small reception power, and thereby the likelihood of the systematic bits in the receiver can be increased. Then, it is possible to make a significance of the information correspond to a magnitude of an average reception power, and enhance transmission performances.

(4) In the radio communication system of the present invention, the transmission method is determined so that the respective transmission apparatuses transmit different bits. Since respective base stations transmit mutually different signals, it is possible to mitigate the giving interference. Then, a coding gain by an error correcting code can be enhanced. Unlike a case where an Alamouti code is used, a transmission rate is not decreased even when the number of transmission base stations is three or more.

(5) In the radio communication system of the present invention, the respective transmission apparatuses determine a retransmission method of a transmission signal in accordance with an average reception power in the reception apparatus. Thereby, it is possible to enhance transmission performances at the time of retransmission of the transmission signal, and mitigate the giving interference to other cells.

(6) In the radio communication system of the present invention, a transmission apparatus causing a smaller average reception power in the reception apparatus than other transmission apparatuses does not retransmit a transmission signal when neither an ACK signal nor a NACK signal can be detected.

That neither an ACK signal nor a NACK signal can be detected (DTX) means that a channel state between a transmission apparatus and a reception apparatus is very bad, and the reliability of the first time transmission data is very low. In such a case, performing transmission anew rather than retransmitting can enhance transmission performances. On the other hand, when a NACK signal is detected, the receiver would only lack the power somewhat, and it is expected that a probability that a communication will be successful by the next retransmission is high.

(7) The transmission apparatus of the present invention is the one performing communication with a reception apparatus in coordination with other apparatus, wherein a transmission method used by the respective transmission apparatuses is determined in accordance with a magnitude relation of an average reception power among the respective transmission apparatuses in the communication, and the whole transmission performances are enhanced. Thereby, efficient transmission becomes possible in accordance with a significance of each channel, and transmission performances can be enhanced.

(8) The reception apparatus of the present invention is the one with which a plurality of transmission apparatuses performs communication in a coordinated manner, wherein the reception apparatus transmits information on an average reception power for each of the transmission apparatuses in the communication to the respective transmission apparatuses, makes the respective transmission apparatuses determine a transmission method in accordance with a magnitude relation of the transmitted average reception power, and enhances the whole transmission performances. Thereby, efficient transmission becomes possible in accordance with a significance of each channel, and transmission performances can be enhanced.

### Advantage of the Invention

According to the present invention, when an average reception power from respective base stations in a terminal differs, transmission performances can be enhanced without giving more interference by performing communication in consideration of a channel state with respective base stations being different.

### BRIEF DESCRIPTION OF THE DRAWINGS

FIG. 1 is a schematic diagram illustrating an example of a radio communication system;

FIG. 2A is a block diagram illustrating a configuration of a base station;

FIG. 2B is a block diagram illustrating a configuration of a base station;

FIG. 3 is a figure illustrating an information bit sequence of encoding;

FIG. 4 is a figure illustrating a reception power of a signal transmitted from a base station;

FIG. 5A is a figure illustrating an example of a puncture pattern;

FIG. 5B is a figure illustrating an example of a puncture pattern;

FIG. 5C is a figure illustrating an example of a puncture pattern;

FIG. 6 is a figure illustrating an information bit sequence of encoding;

FIG. 7 is a block diagram illustrating a configuration of a terminal;

FIG. 8 is a block diagram illustrating a configuration of a reception processing part; and

FIG. 9 is a block diagram illustrating a configuration of a base station.

### BEST MODES FOR CARRYING OUT THE INVENTION

Hereinafter, an embodiment of the present invention will be described referring to drawings. Although an example where the present invention is applied to OFDM (Orthogonal Frequency Division Multiplexing) as a transmission scheme will be described, the present invention is applicable also to single carrier transmission such as DFT-S-OFDM (Discrete Fourier Transform Spread OFDM), Clustered DFT-S-OFDM or the like. Furthermore, to an embodiment described below, frequency division multiplexing (FDM) is applied, and respective base stations (transmission apparatuses) transmit signals by different frequencies. However, time division multiplexing (TDM), space division multiplexing (SDM) and code division multiplexing (CDM) may be applied. In addition, although two base stations perform communication in a coordinated manner, a plurality of base stations may perform communication in a coordinated manner.

### First Embodiment

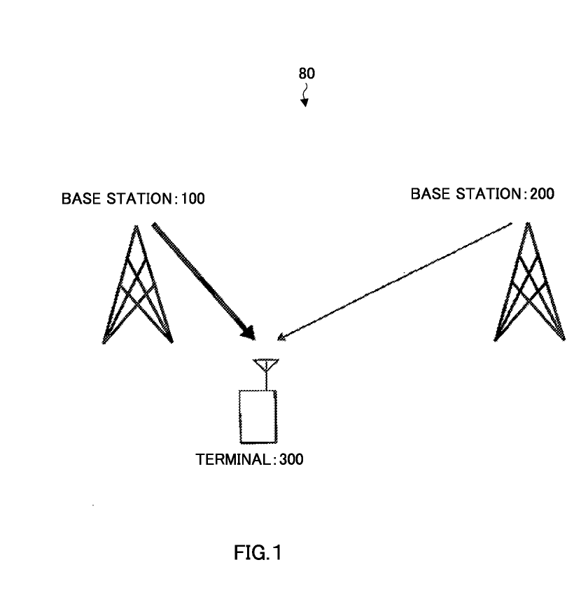

FIG. 1 is a schematic diagram illustrating an example of a radio communication system 80. In the example of the radio communication system 80 illustrated in FIG. 1, a base station 100 and a base station 200 are communicating with a terminal 300, and in the terminal 300, a reception power from the base station 100 is larger than that from the base station 200. Therefore, the terminal 300 is mainly connected with the base station 100. At this time, the base station 100 is called an anchor cell for the terminal 300.

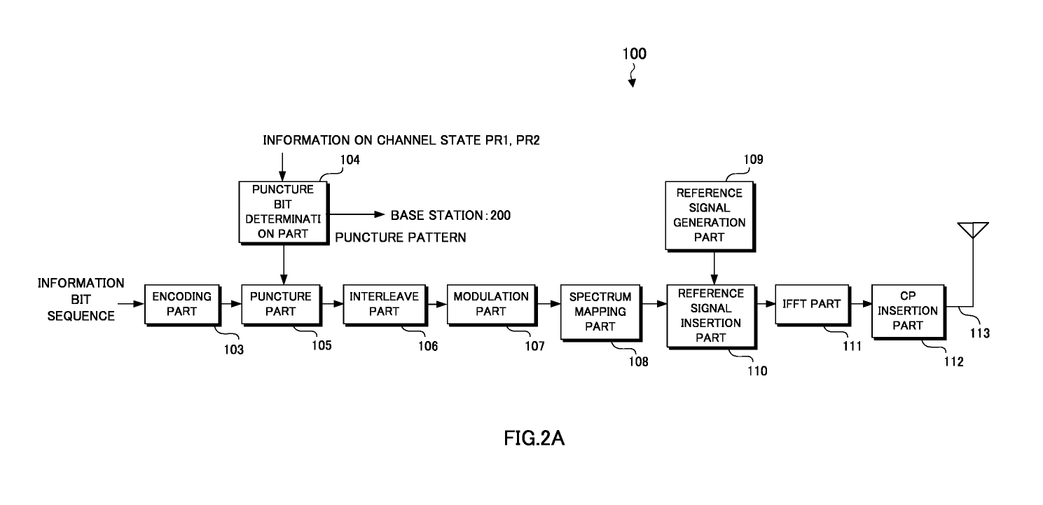

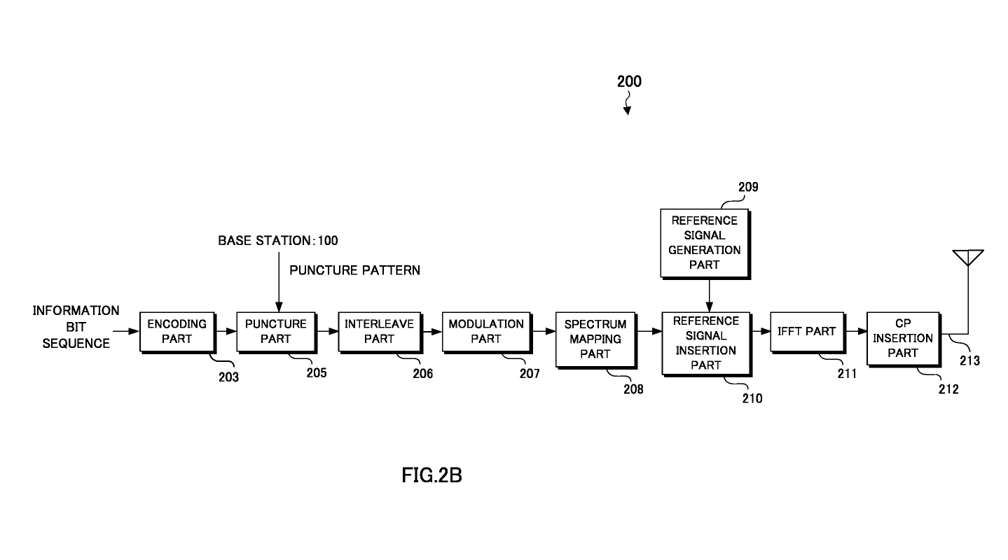

FIG. 2A is a block diagram illustrating a configuration of the base station 100. the base station 100 includes an encoding part 103, a puncture bit determination part 104, a puncture part 105, an interleave part 106, a modulation part 107, a spectrum mapping part 108, a reference signal generation part 109, a reference signal insertion part 110, an IFFT part 111, a CP insertion part 112, and an antenna 113. An information bit sequence is input into the encoding part 103. In the encoding part 103, error correction encoding, such as a turbo code or a low density parity check (LDPC) code, is performed. In the present embodiment, a case where the turbo code is used will be described. The encoding part 103 performs encoding with a coding rate of 1/3. An encoded bit sequence after the encoding will be described later. The encoded bit sequence is input into the puncture part 105. A puncture pattern used for puncturing in the puncture part 105 is notified from the puncture bit determination part 104. The puncture bit determination part 104 notifies also the base station 200 of the puncture pattern. In this way, the determination of puncture bits is performed, in principle, by the base station 100 which is the anchor cell. An operation of the puncture bit determination part 104 will be described later.

As for the bit sequence punctured in the puncture part 105, after the sequence order is changed in the interleave part 106, modulation such as QPSK (Quadrature Phase Shift Keying) and 16QAM (Quadrature Amplitude Modulation) is performed in the modulation part 107. Subsequently, assignment of a modulation symbol to a predetermined frequency is performed in the spectrum mapping part 108, and after that, in the reference signal insertion part 110, multiplexing of a reference signal generated by the reference signal generation part 109 is carried out, and after that, IFFT (IFFT; Inverse Fast Fourier Transform) is applied in the IFFT part 111, and thereby, conversion from frequency domain signals to time domain signals is performed. After addition of CP (Cyclic Prefix) in the CP insertion part 112, transmission is performed from the antenna 113.

Next, a configuration of the base station 200 will be described. FIG. 2B is a block diagram illustrating a configuration of the base station 100. The same information bit sequence as that of the base station 100 is to be input also into the base station 200 (or the encoded bit sequence after the error correction encoding may be input directly to the puncture part 205). The base station 200 includes an encoding part 203, a puncture part 205, an interleave part 206, a modulation part 207, a spectrum mapping part 208, a reference signal generation part 209, a reference signal insertion part 210, an IFFT part 211, a CP insertion part 212, and an antenna 213. The configuration of the base station 200 is almost the same as that of the base station 100. However, a puncture pattern input into the puncture part 205 is notified from the puncture bit determination part 104 of the base station 100. In addition, a modulation scheme in the modulation part 207 may be different from that in the modulation part 107 of the base station 100.

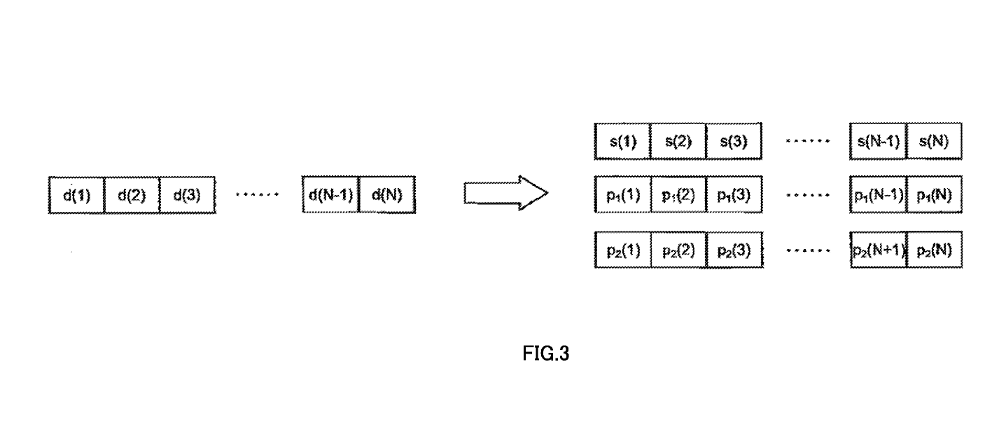

Next, the encoding performed in the encoding part 103 will be described. FIG. 3 is a figure illustrating the encoded bit sequence. As illustrated in FIG. 3, the information bit sequence of N bits is encoded into a total of 3 N bits including systematic (organization) bits of N bits: s (1) to s (N), first parity (redundancy) bits of N bits: p1 (1) to p1 (N), and second parity (redundancy) bits of N bits: p2 (1) to p2 (N).

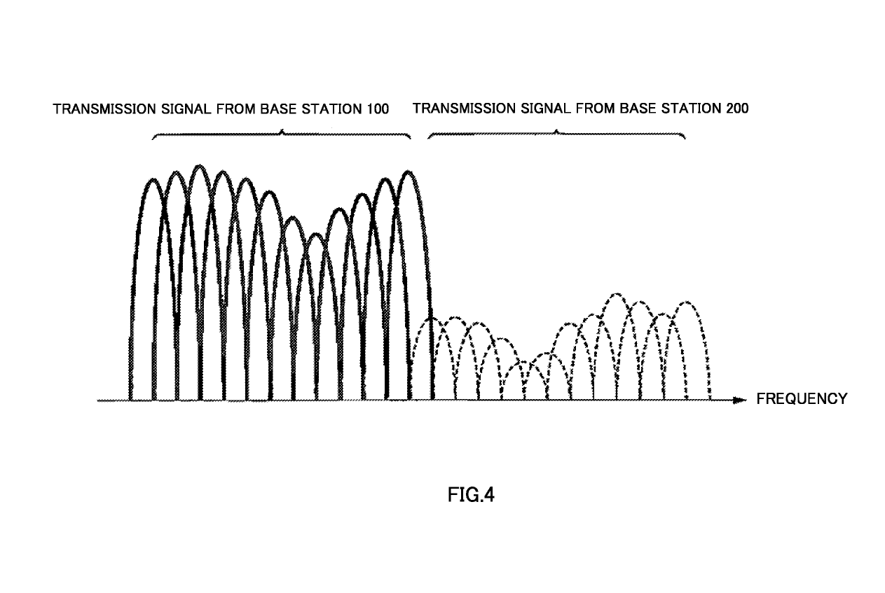

Next, a determining method of the puncture pattern in the puncture bit determination part 104 will be described. In the present embodiment, it is assumed that a plurality of base stations transmits information with respect to the same information bits. FIG. 4 is a figure illustrating a reception power of signals transmitted from the base stations 100 and 200. A case where an average reception power of the signals transmitted from the base station 100 is larger than an average reception power of the signals transmitted from the base station 200, as illustrated in FIG. 4, will be described. Here, the average reception power refers to a frequency average of the reception power.

When the average reception power differs depending on the base stations, it can be considered that the base station performs transmission by using the modulation scheme and coding rate (MCS; Modulation and Coding Scheme) suitable for the average reception power. That is, by transmitting the same encoded bits from respective base stations and synthesizing the reception signal from the respective base stations, a reception signal to noise power ratio (SNR; Signal-to-Noise power Ratio) of the reception encoded bits can be made to be enhanced. However, the method of transmitting the same encoded bits from a plurality of base stations in this way enables SNR to be enhanced, but cannot increase coding gain by an error correcting code.

Therefore, in the present embodiment, respective base stations 100 and 200 transmit different encoded bits. The puncture bit determination part 104 receives information on a channel state PR1 between the base station 100 and the terminal 300, and information on a channel state PR2 between the base station 200 and the terminal 300. In addition, as for the turbo code, although systematic bits and parity bits are generated, the systematic bits are more important than the parity bits, and, even in general puncturing, the parity bits are punctured. Therefore, when the channel state PR1 is better than the channel state PR2, the puncture bit determination part 104 inputs the puncture pattern as the puncture pattern in the base station 100 into the puncture part 105 so as to transmit only the systematic bits.

In this way, transmission-encoded-bits are determined so that the base station 100 providing large average reception power for the terminal 300 may transmit the systematic bits preferentially, and the base station 200 providing small average reception power may transmit the parity bits preferentially. Thereby, a reception quality of the systematic bits in the terminal 300 can be enhanced. As a result, transmission performances can be enhanced. Then, since respective base stations transmit mutually different signals, it is possible to mitigate the giving interference. As a result, the coding gain by the error correcting code can be enhanced.

The puncture bit determination part 104 further performs puncturing for encoded bits (punctured) which the base station 100 does not transmit to achieve a predetermined coding rate, and notifies the base station 200 of the puncture pattern used for puncturing in the puncture part 205 of the base station 200. The puncture part 205 of the base station 200 performs puncturing in accordance with the puncture pattern notified from the puncture bit determination part 104 of the base station 100.

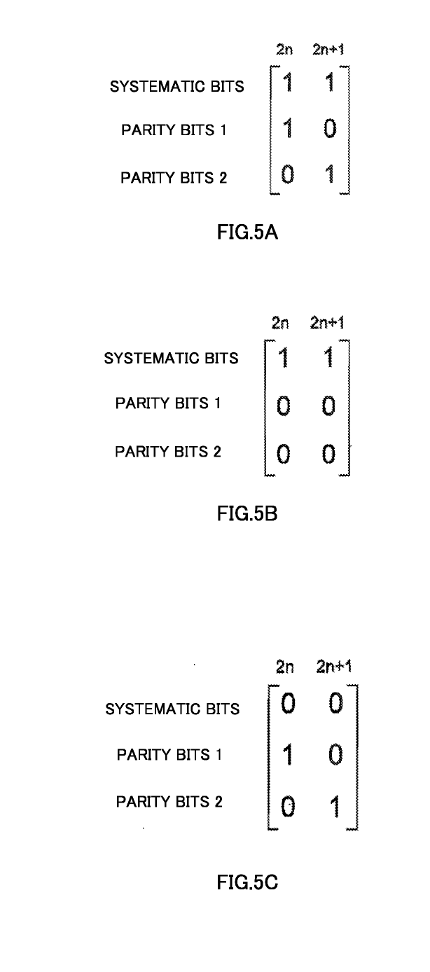

FIGS. 5A to 5C illustrate an example of a puncture pattern. For example, when performing error correction encoding with a coding rate of 1/2, the puncture pattern is usually indicated as illustrated in FIG. 5A. A row of the matrix indicates systematic bits, parity bits 1, and parity bits 2, and a column of the matrix indicates the 2n-th bits and the (2n+1)th bits, and “1” indicates transmitting, and “0” indicates not transmitting (puncturing). An example of the puncture pattern in the base station 100 in the present embodiment is illustrated in FIG. 5B. In the example illustrated in FIG. 5B, the base station 100 will transmit only the systematic bits.

A puncture pattern in the base station 200 is illustrated in FIG. 5C. Since systematic bits have been transmitted by the base station 100, encoded bits except the systematic bits among encoded bits for satisfying the coding rate 1/2 are transmitted from the base station 200. That is, p1 (0), p2 (1), p1 (2), p2 (3), and . . . will be transmitted. In this way, in accordance with a magnitude relation of an average reception power, a puncture pattern after the error correction encoding is determined. As a result, even though an average reception power differs among the base stations, a transmission antenna diversity effect is acquired.

Besides, although, for simplification of description, it has been described that the base station 100 transmits only systematic bits, and the base station 200 transmits only parity bits, in consideration of the channel state with respective base stations, included in the present invention are the case where parity bits in addition to systematic bits are transmitted from the base station 100, and also the case where systematic bits in addition to parity bits are transmitted from the base station 200.

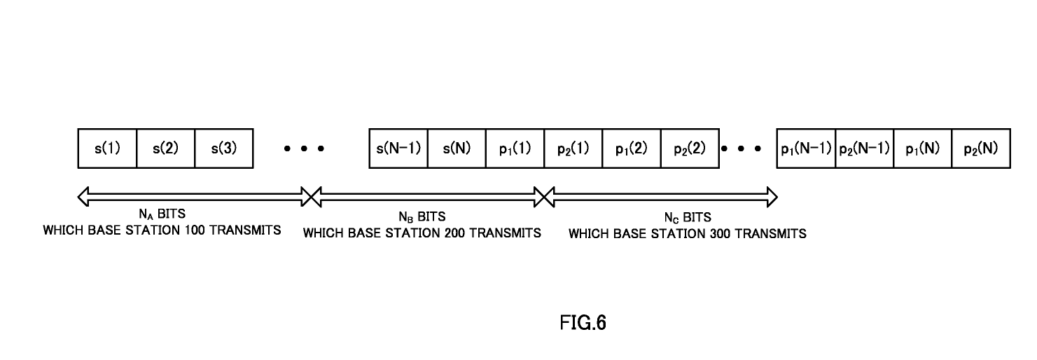

Next, a case where three or more base stations perform communication in a coordinated manner will be described using FIG. 6. It is assumed that, as a base station, a base station 100, a base station 200, and a base station 400 exist and perform transmission in a coordinated manner. In FIG. 6, a sequence is formed by arranging parity bits 1 and parity bits 2 alternately in the rear part of systematic bits of N bits. First, the base station 100, which is an anchor cell, transmits systematic bits of N_{A} bits. The base station 200, since the base station 100 transmits systematic bits of N_{A} bits, will transmit N_{B} bits from the (N_{A}+1)th bit. Similarly, the base station 400 transmits N_{C} bits from the (N_{A}+N_{B}+1)th bit. Besides, here, although an example where the base station 100 transmits only systematic bits is illustrated, the base station 100 will transmit also parity bits in the case of N_{A}>N.

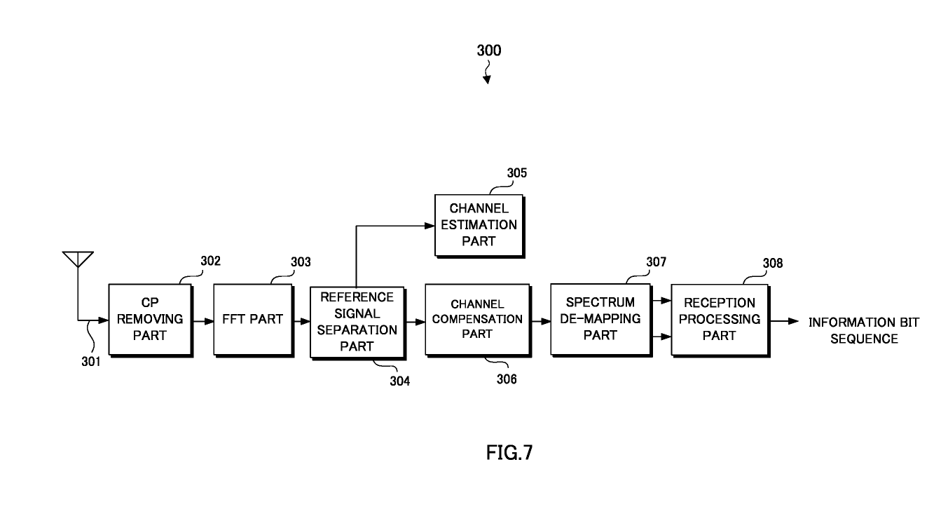

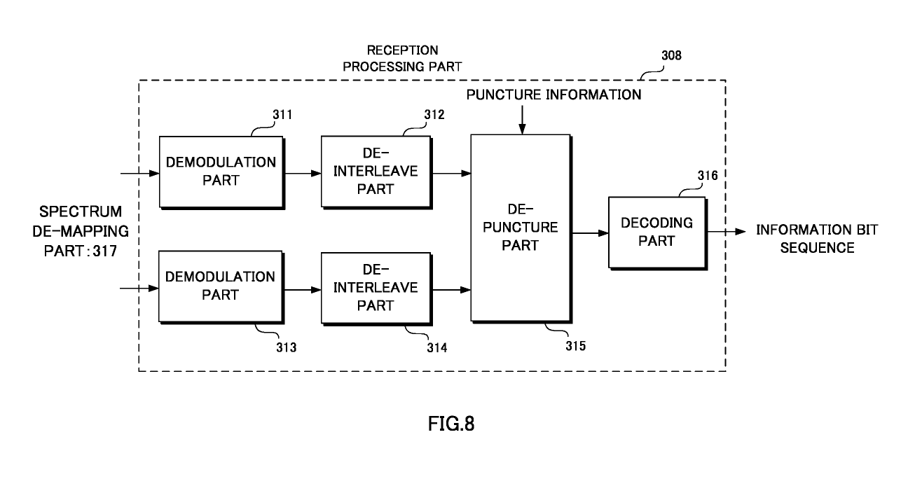

Next, a configuration of the terminal 300 will be described. FIG. 7 is a block diagram illustrating the configuration of the terminal 300. A reception signal received by an antenna 301 is input into a CP removing part 302, and CP added in the base stations 100 and 200 is removed. An output of the CP removing part 302 is input into a FFT part 303. In the FFT part 303, processing to convert a time domain signal into a frequency-domain signal is performed. The frequency-domain signal which the FFT part 303 outputs is input into a reference signal separation part 304. In the reference signal separation part 304, the reference signal multiplexed in the base stations 100 and 200 is demultiplexed, and is input into a channel estimation part 305.

In the channel estimation part 305, channel estimation is performed on the basis of the input reception reference signal, and the channel estimation value is input into a channel compensation part 306. On the other hand, the signal which the reference signal separation part 304 outputs except the reference signal, that is data signal, is input into the channel compensation part 306. In the channel compensation part 306, processing is performed which compensates an influence the data signal has received in the channel by using the channel estimation value input from the channel estimation part 305. The output of the channel compensation part 306 is input into a spectrum de-mapping part 307, and only the frequencies used for transmission by the base station 100 and base station 200 are extracted individually, which are input into the spectrum de-mapping part 307. Each output of the spectrum de-mapping part is input into a reception processing part 308, and the reception processing part 308 outputs an information bit sequence of 1 or 0.

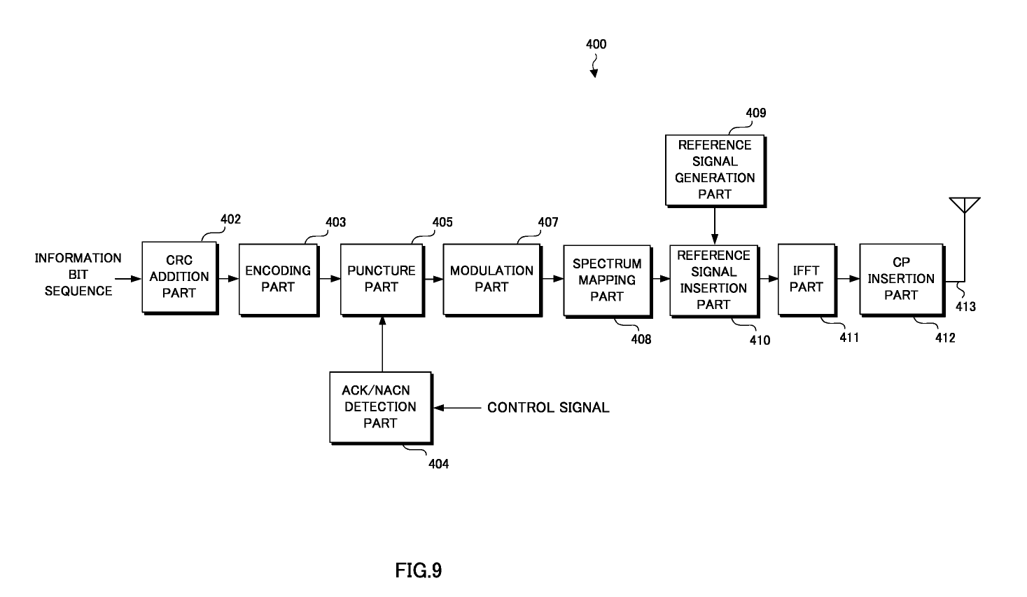

A configuration of the reception processing part 308 will be described. FIG. 8 is a block diagram illustrating the configuration of the reception processing part 308. Each output of the spectrum de-mapping part 307 is input into a demodulation part 311 and a demodulation part 313 within the reception processing part 308. The output of the spectrum de-mapping part 307 for the base station 100 is input into the demodulation part 311. In the demodulation part 311, bits LLRs (Log-Likelihood Ratio) are computed on the basis of the modulation performed by the base station 100, which will be input into a de-interleave part 312. In the de-interleave part 312, processing is performed which restores the bit order interleaved in the base station 100, and the bits are input into a de-puncture part 315. The output of the spectrum de-mapping part 307 for the base station 200 is also subjected to the same processing as for the output to the base station 100 performed by a demodulation part 313 and a de-interleave part 314, and is input into the de-puncture part 315.

In the de-puncture part 315, among encoded bits, with respect to the bits transmitted by respective base stations, the bit LLR input from the de-interleave part 312 or de-interleave part 314 is input on the basis of puncture information, and with respect to the encoded bits which have not been transmitted by any of the base stations, zeros are input. Besides, when a plurality of base stations has transmitted the same encoded bits, the bit LLR from respective base stations may be combined (added). The de-punctured bit sequence is input into a decoding part 316, and error correction decoding processing is performed in the decoding part 316. The decoding part 316 carries out hard decision of the bit LLRs of the systematic bits after the error correction decoding, and outputs it as an information bit sequence.

On the other hand, the terminal 300 transmits the information on the average reception power for every base station to respective base stations.

Thus, the radio communication system 80, in accordance with a magnitude relation of an average reception power between a terminal and respective base stations, determines a transmission method used by respective base stations, and enhances the whole transmission performances. As a result, the transmission performances can be enhanced.

Besides, in the above-mentioned embodiment, although the base station 100 has been configured so as to comprise the puncture bit determination part 104, the base station may be one which has an antenna located at hundreds of meters away as a RRE (Remote Radio Element).

Since encoded bits which are different in respective base stations are transmitted as mentioned above, a coding gain will be able to be acquired effectively. In addition, systematic bits which account for an important role in encoded bits are transmitted from the base station having the good channel state, the parity bits are transmitted from the base station having the small reception power, and thereby the likelihood of the systematic bits in the terminal can be enhanced, thus enabling an effective decoding to be performed.

### Second Embodiment

In the embodiment mentioned above, although a transmission method of a transmission signal is determined in accordance with an average reception power, a retransmission method of a transmission signal may be determined in accordance with the average reception power. The case enables transmission performances at the time of retransmission of a transmission signal to be enhanced, which makes it possible to mitigate the giving interference to other cells.

Generally, a check code called CRC (Cyclic Redundancy Check) is added to transmission data, and error detection has become possible in a receiver. When an error is not detected, the receiver notifies the transmitter of an ACK (ACKnowledge) bit, and when an error is detected, a NACK (Negative ACK) bit is notified. The transmitter notified of the NACK bit performs retransmission of the transmission data by a method, such as CC (Chase Combining) or IR (Incremental Redundancy). When the transmitter can detect neither ACK nor NACK, judging as DTX (Discontinuous Transmission), the transmitter usually performs the retransmission. In the present embodiment, described is control at the time of the retransmission when a reception power from respective base stations has a difference in the downlink CoMP.

FIG. 9 is a block diagram illustrating a transmitter configuration of the base station 400. The base station 100 includes a CRC addition part 402, an encoding part 403, an ACK/NACK detection part 404, a puncture part 405, a modulation part 407, a spectrum mapping part 408, a reference signal generation part 409, a reference signal insertion part 410, an IFFT part 411, a CP insertion part 412, and an antenna 413. The base station 400 has the same configuration as that of the base station 100 in the first embodiment. A terminal, although not illustrated, is one where an ACK/NACK detection configuration and an ACK/NACK notification configuration to a base station are added to the configuration illustrated in FIG. 7, and one which has a terminal configuration generally used. At the beginning, an information bit sequence is input into the CRC addition part 402, and CRC is added. Subsequently, it is input into the encoding part 403 and is input into the puncture part 405 after error correction encoding is performed. On the other hand, the ACK/NACK detection part receives control information notified from the terminal 300, and inputs ACK, NACK, or DTX into the puncture part 405.

The puncture part 405, in consideration of a coding rate to be transmitted and ACK/NACK information from the ACK/NACK detection part 404, determines a puncture pattern. That is, at the time of the first transmission, or at the time when the input from the ACK/NACK detection part 404 is ACK, the information that is not yet transmitted is punctured with a predetermined coding rate, and is transmitted. On the other hand, when the input from the ACK/NACK detection part 404 is NACK, the same puncture pattern as that at the first transmission is applied in the case of CC mode, and in the case of IR mode, a puncture such that the encoded bits not transmitted at the first transmission are transmitted preferentially is performed. In this way, a base station (anchor cell) which establishes main connection and exchanges control information with a terminal such as a mobile station performs communication by the above-mentioned control.

On the other hand, other than an anchor cell, base stations which perform a coordinated communication will be described. Also in the base stations other than the anchor cell, when ACK is detected in the ACK/NACK detection part 404, the next data is transmitted by a predetermined method. In addition, when DTX is detected, bits transmitted at the first transmission will be transmitted. On the other hand, when NACK is detected, the base station does not perform transmission.

Notification of DTX means that a channel state between the base station and the terminal is very bad, and that the reliability of the first time transmission data is very low, and therefore, performing transmission anew can enhance characteristics. On the other hand, when NACK is detected, the terminal would only lack the power somewhat, and it is expected that a probability that a communication will be successful by the next retransmission is high. Therefore, since it is enough if only the anchor cell among the base stations which perform transmission in a coordinated manner performs transmission, other base stations do not perform transmission. As for other base stations, with respect to frequency resource used at the time of the first transmission, if no transmission has been performed, it is possible to mitigate the giving interference to other cells. Alternatively, it is also possible to enhance spectrum efficiency by not no-transmitting but allocating the resource to other terminals. Besides, the present embodiment may also be applied to an RRE system.

In this way, if a base station which performs a coordinated communication by ACK/NACK determines whether to perform data transmission or to stop a radio wave, it is possible to suppress the giving interference to neighboring cells. Furthermore, since resources (frequency, time, etc.) which have not been used for transmission can be allocated to other terminals, spectrum efficiency can be enhanced.

### INDUSTRIAL APPLICABILITY

### DESCRIPTION OF SYMBOLS

80: Radio communication system
100, 200, and 400: Base station (transmission apparatus)
103, 203, and 403: Encoding part
104: Puncture bit determination part
105, 205, and 405: Puncture part
106 and 206: Interleave part
107, 207, and 407: Modulation part
108, 208, and 408: Spectrum mapping part
109, 209, and 409: Reference signal generation part
110, 210, and 410: Reference signal insertion part
111, 211, and 411: IFFT part
112, 212, and 412: CP insertion part
113, 213, and 413: Antenna
300: Terminal (reception apparatus)
301: Antenna
302: CP removing part
303: FFT part
304: Reference signal separation part
305: Channel estimation part
306: Channel compensation part
307: Spectrum de-mapping part
308: Reception processing part
311 and 313: Demodulation part
312 and 314: De-interleave part
315: De-puncture part
316: Decoding part
402: CRC addition part
404: ACK/NACK detection part
PR1, PR2: Channel state

1. A radio communication system in which a plurality of transmission apparatuses performs communication with a reception apparatus in a coordinated manner, wherein
a transmission method used by said respective transmission apparatuses is determined in accordance with a magnitude relation of an average reception power among said respective transmission apparatuses in said communication, and the whole transmission performances are enhanced.

2. The radio communication system according to claim 1, wherein a puncture pattern after an error correction encoding is determined in accordance with a magnitude relation of an average reception power in said reception apparatus.

3. The radio communication system according to claim 1, wherein said transmission method is determined so that
a transmission apparatus causing a large average reception power in said reception apparatus transmits preferentially systematic bits, and a transmission apparatus causing a small average reception power in said reception apparatus transmits preferentially parity bits.

4. The radio communication system according to any of claim 1, wherein said transmission method is determined so that said respective transmission apparatuses transmit different bits.

5. The radio communication system according to claim 1, wherein said respective transmission apparatuses determine a retransmission method of a transmission signal in accordance with an average reception power in said reception apparatus.

6. The radio communication system according to claim 5, wherein a transmission apparatus causing a smaller average reception power in said reception apparatus than other transmission apparatuses does not retransmit a transmission signal when neither an ACK signal nor a NACK signal can be detected.

7. A transmission apparatus performing communication with a reception apparatus in coordination with other apparatus, wherein
a transmission method used by said respective transmission apparatuses is determined in accordance with a magnitude relation of an average reception power among said respective transmission apparatuses in said communication, and the whole transmission performances are enhanced.

8. A reception apparatus with which a plurality of transmission apparatuses performs communication in a coordinated manner, wherein
the reception apparatus transmits information on an average reception power for each of said transmission apparatuses in said communication to said respective transmission apparatuses, makes said respective transmission apparatuses determine a transmission method in accordance with a magnitude relation of said transmitted average reception power, and enhances the whole transmission performances.

9. The radio communication system according to claim 2, wherein said transmission method is determined so that
a transmission apparatus causing a large average reception power in said reception apparatus transmits preferentially systematic bits, and a transmission apparatus causing a small average reception power in said reception apparatus transmits preferentially parity bits.

10. The radio communication system according to claim 2, wherein said transmission method is determined so that said respective transmission apparatuses transmit different bits.

11. The radio communication system according to claim 3, wherein said transmission method is determined so that said respective transmission apparatuses transmit different bits.
